(19) United States
(12) Patent Application Publication
(10) Pub. No.: US 2021/0071784 A1
(43) Pub. Date: Mar. 11, 2021

(54) SADDLE PIPE SUPPORT

(71) Applicant: HYDRA-ZORB, Auburn Hills, MI (US)

(72) Inventors: Robert DODGE, Birmingham, MI (US); Mark SCHWAGER, Washington Twp, MI (US)

(73) Assignee: HYDRA-ZORB, Auburn Hills, MI (US)

(21) Appl. No.: 16/961,725

(22) PCT Filed: Jan. 14, 2019
(86) PCT No.: PCT/US2019/013450

§ 371 Date: Jul. 13, 2020

Related U.S. Application Data
(60) Provisional application No. 62/617,261, filed on Jan. 14, 2018.

(51) Int. Cl. F16L 3/13

(52) U.S. Cl. CPC F16L 3/13

(57) ABSTRACT

A pipe support is coupled to an elongated channel for receiving and supporting a pipe. The channel includes a base and a pair of spaced apart sidewalls extending from the base to an end plate. A flange projects from each end plate towards the base and defines a slot therebetween. The pipe support includes a body portion extending axially between opposite ends and having an inner surface and an outer surface. The body portion includes a generally arcuate bottom floor and a pair of spaced apart sidewalls projecting generally upwardly from the bottom floor. A plurality of axially spaced channel clips project downwardly from the outwardly flared lip portion adapted for engage the sidewalls of the channel and frictionally coupling the pipe support to the channel.

### CROSS-REFERENCE TO RELATED APPLICATIONS

This application claims priority to and all the benefits of U.S. Provisional Application No. 62/617,261, filed on Jan. 14, 2018.

### BACKGROUND OF THE INVENTION

### 1. Field of the Invention

The present invention relates to a pipe support. More particularly, the invention relates to a saddle pipe support adapted for connection to a channel for receiving and supporting a pipe.

### 2. Description of Related Art

Conventional pipes are used to convey or transfer fluids in various commercial and industrial applications and buildings, such as water and sprinkler systems, refrigeration systems, and heating/cooling systems. The pipes are commonly encased in a cellular foam insulation tubing, which maintains the fluid within the pipes at a desired temperature. The pipe insulation tubing is commonly provided in predetermined lengths that are aligned end-to-end to cover an entire length of pipe.

In a typical application and installation, the insulated pipe, that is, the pipe encased by the insulation tubing, is disposed along a support structure, such as a ceiling of the building. The insulated pipe is commonly supported along the support structure by a plurality of spaced apart clevis hangers or straps. An elongated metal U-shaped channel is typically fixedly secured to the support structure or ceiling for supporting the clevis hangers. Each clevis hanger typically includes an upper member mounted to the channel and a generally U-shaped lower member coupled to the upper member for supporting the insulated pipe spaced below the channel. The shape of the lower member complements that of the outer periphery of the insulated pipe, thereby allowing the clevis hanger to support and retain the insulated pipe along the channel. Examples of common clevis hangers for supporting insulated pipes are shown in U.S. Pat. Nos. 7,207,527 and 7,520,475.

It is also known to provide a saddle-shaped pipe support adapted to be connected to the U-shaped channel and shaped complementary to the insulated pipe to support a longitudinal length of the insulated pipe. The saddle pipe support includes a body portion having a curved bottom and arcuate upwardly extending walls for receiving and supporting the insulated pipe. A pair of spaced apart members having inwardly extending hooks or barbs extend downwardly from the body portion for receiving the outer walls of the channel therebetween to secure the saddle pipe support to the channel. A saddle pipe support known in the prior art is shown in U.S. Pat. No. 8,074,943.

However, it remains desirable to provide a more versatile, secure, and stable connection between the saddle pipe support and the channel for supporting the insulated pipe.

### SUMMARY OF THE INVENTION

A pipe support is provided for receiving and supporting a pipe. The pipe support comprises a body portion extending axially between opposite ends and having an inner surface and an outer surface. The body portion includes a generally arcuate bottom floor and a pair of spaced apart sidewalls projecting generally upwardly from the bottom floor. A plurality of axially spaced apart channel clips project downwardly from the outer surface of the body portion opposite the sidewalls. The channel clips comprise a leg portion and at least one outwardly flared lip portion adapted for frictionally coupling the pipe support to a support structure.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of the saddle pipe support according to one embodiment of the invention for supporting an insulated pipe;

FIG. 2 is an end view of the saddle pipe support;

FIG. 3 is a top view of the saddle pipe support;

FIG. 4 is a side view of the saddle pipe support connected to a U-shaped channel; and

FIG. 5 is a bottom view of the saddle pipe support.

### DETAILED DESCRIPTION OF THE EMBODIMENTS

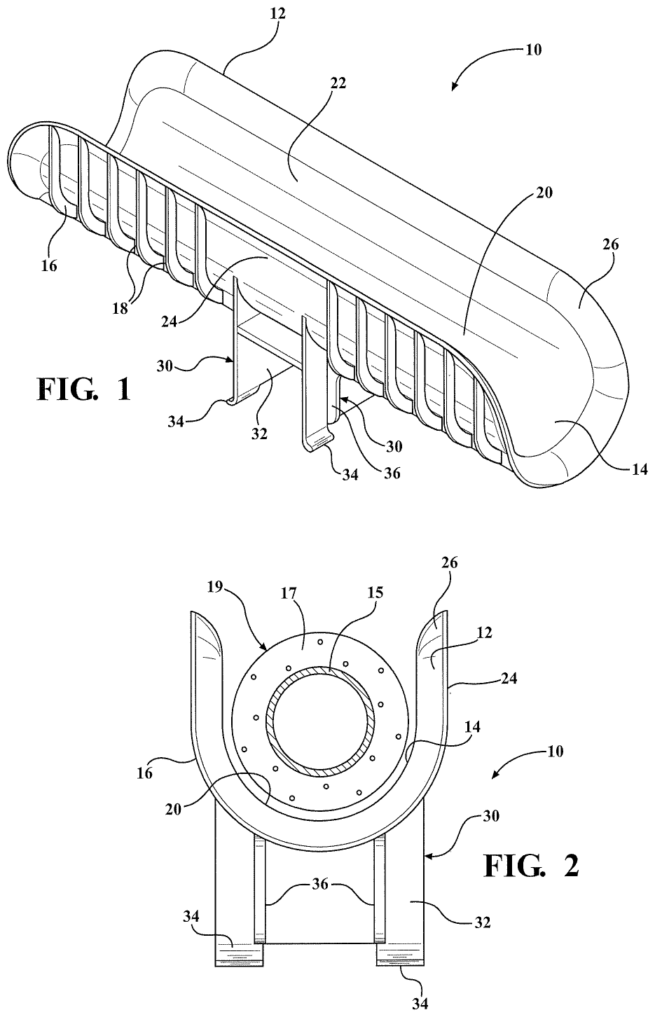

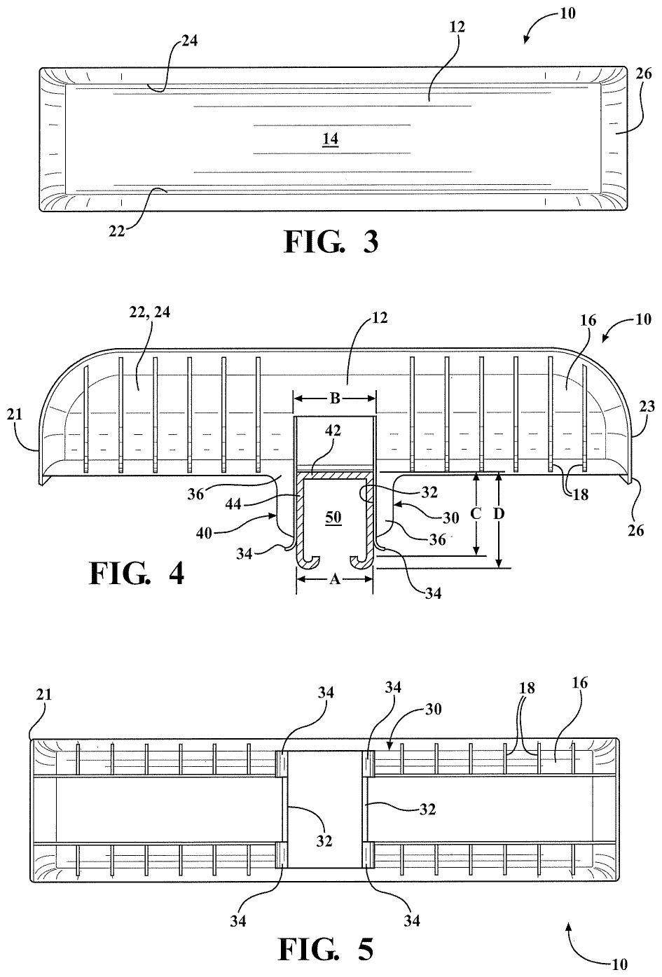

Referring to the Figures, wherein like numerals indicate like or corresponding parts throughout the several views, a saddle pipe support 10, preferably fabricated by molded plastic, is shown in FIGS. 1-5 for supporting an elongated pipe 15. The pipe 15 is generally a fluid pipe used in commercial or industrial buildings for transferring fluid in water, refrigeration, or heating/cooling systems. Further, the pipe 15 is typically encased in a cellular foam insulation tubing 17 for maintaining the temperature of the fluid in the pipe 15, collectively referred to herein as an insulated pipe and shown at 19.

The saddle pipe support 10 is adapted to be removeably coupled to a support structure 40, commonly known as an elongated metal U-shaped channel, which is typically fixedly secured to a wall or ceiling of the building. The support structure 40, or channel, which is commonly known in the art, includes a flat base 42 extending between a pair of spaced apart upright or vertical sidewalls 44. An end plate 46 projects inwardly from each of the respective sidewalls 44 and is generally parallel to the base 42. Each end plate 46 terminates with an upwardly turned flange 48 projecting toward but spaced above the base 42. An elongated slot 50 is defined between the spaced apart and opposite facing flanges 48.

The pipe support 10 includes an elongated semi-cylindrical or generally U-shaped body portion 12 having an inner support surface 14 for supporting the insulated pipe 19 and an outer surface 16 reinforced by a plurality of transverse structural ribs 18. More specifically, the body portion 12 includes an arcuate bottom floor 20 and a pair of spaced apart upwardly or vertically extending sidewalls 22, 24. The body portion 12 extends axially, or longitudinally, between opposite ends 21, 23 forming a generally U-shaped cross-section or the shape of a saddle. A peripheral edge or rim 26 of the body portion 12 is tapered, curved, or flared outwardly to prevent the insulation tubing 17 surrounding the pipe 15 from catching on a distal edge of the body portion 12. The rim 26 also forms a downwardly curved lip defining each opposite end 21, 23 of the body portion 12. The structural ribs 18 are spaced apart transverse to the axial length of the body portion 12 and extend around the outer surface 16 of the bottom floor 20 and each sidewall 22, 24 to provide structural rigidity and strength to the pipe support 10.

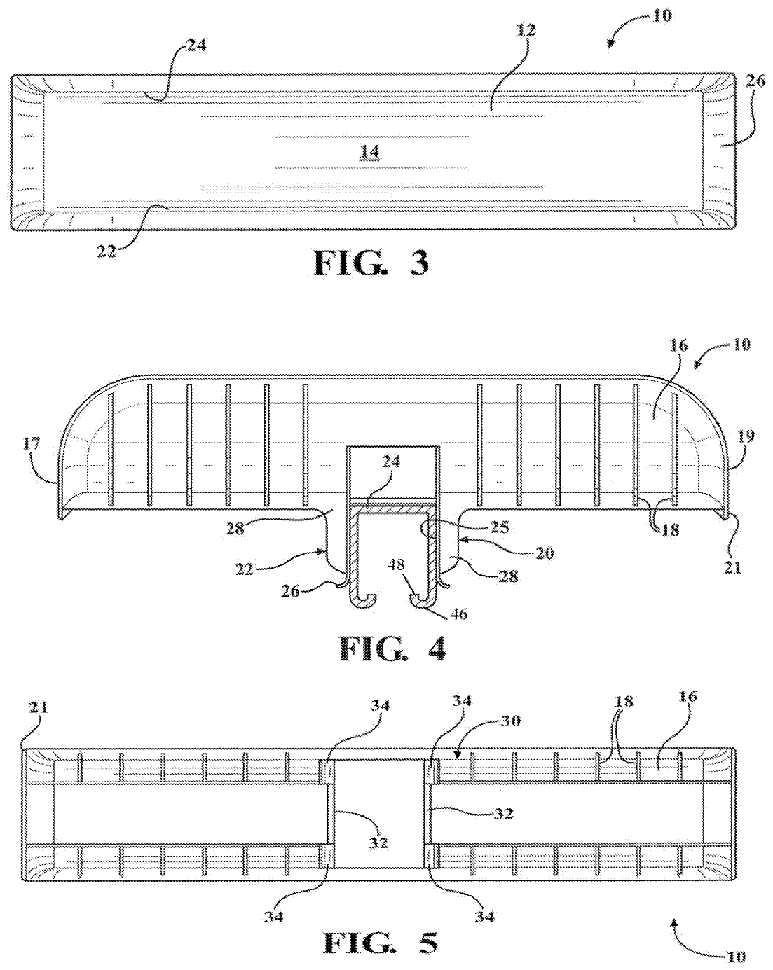

A plurality of axially spaced apart channel clips 30 project downwardly from the outer surface 16 of the body portion 12 for connection to the elongated channel 40, as shown in FIG. 4. More specifically, each channel clip 30 includes vertical leg portion 32 extending downwardly from the body portion 12 to a distal outwardly flared lip portion 34 projecting outwardly from the distal end of each leg portion 32 to secure the saddle pipe support 10 to the channel 40. The leg portions 32 are angled or tapered inwardly towards each other axially from the body portion 12 to the lip portion 34 wherein the space between the opposing leg portions 32 adjacent the body portion 12 is greater than the spaced between the opposing leg portions 32 adjacent the lip portions 34. Further, the lip portion 34 may be one continuous outwardly flared lip portion extending from the distal end of the leg portion 32 or a pair or more of outwardly flared lip portions 34 spaced apart and extending from the distal end of the leg portion 32 as shown. Each of the leg portions 32 further includes a compression support rib 36 extending from the body portion 12 and generally perpendicular to the planar surface of each leg portion 32 to provide constant and consistent spacing between the leg portions 32 and resist flexing therebetween. More specifically, as shown in FIGS. 1 and 2, a pair of parallel and spaced apart support ribs 36 extend from the body portion and planar surface of each leg portion 32.

In operation, the longitudinal axis of the saddle pipe support 10 is arranged transverse or perpendicular to the longitudinal axis of the channel 40 as shown in FIG. 4. The body portion 12 of the saddle 10 is sized to receive and support the insulated fluid pipe 19 therein. The leg portions 32 of the channel clips 30 are aligned above the channel 40 such that the lip portions 34 are engaged with the outside sidewalls 44 of the channel 40 to resilient flex the lip portions 34 and the leg portions 32 outwardly as the saddle 10 is seated onto the channel 40. The leg portions 32 of the channel clips 30 straddle the opposite sidewalls 44 of the channel 40 with the lip portions 34 adjacent the bottom of the channel 40. The width A of the channel 40 is greater than the space or width B between the opposing leg portions 32 adjacent the lip portions 34 such that the inwardly angled arrangement between the leg portions 34 maintains constant and continuous pressure of the leg portions 34 against the sidewalls 44 of the channel 40 to frictionally couple and retain the saddle 10 seated along the channel 40 for supporting the insulated pipe 19. Finally, the length C of the leg portions 25 is generally equal to or less than the height D of the channel 40 to allow for access to the slotted opening 50 along the entire length of the channel 40 for additional mounting use of the channel 40 if desired.

Once the saddle pipe support 10 is coupled to the channel 40, a length of insulated pipe 19 may be inserted between the sidewalls 22, 24 and supported by the inner support surface 14 of the body portion 12. It should be appreciated that the saddle pipe support 10 is configured to receive and support a pipe 15 whether encased in the insulation tubing 17 or not. Also, the flared or outwardly curved rim 26 around the periphery of the sidewalls 22 and on the opposite distal ends of the body portion 12 allows the insulated pipe 19 to be moved axially along the saddle pipe support 10 without damage to the insulation tubing 17.

If it desirable to disconnect the saddle pipe support 10 from the channel 40, the channel clips 30 may simply be frictionally released from engagement with the sidewalls 44 to allow the saddle pipe support 10 to be removed from the channel 40.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

1.-9. (canceled)

10. A pipe support adapted for receiving and supporting a pipe, said pipe support comprising:
a body portion extending axially between opposite ends and having an inner surface and an outer surface, said body portion including a generally arcuate bottom floor and a pair of spaced apart sidewalls projecting generally upwardly from said bottom floor; and
a plurality of axially spaced apart channel clips projecting downwardly from said outer surface of said body portion opposite said sidewalls, said channel clips comprising a leg portion and at least one outwardly flared lip portion adapted for frictionally coupling said pipe support to a support structure.

11. The pipe support as set forth in claim 10 further including at least one compression support rib extending from the body portion and generally perpendicular to the planar surface of each leg portion to provide constant and consistent spacing between the leg portions and resist flexing therebetween.

12. The pipe support as set forth in claim 11 wherein said leg portions of said spaced apart channel clips are angled inwardly towards each other from said body portion to said lip portion wherein the space between said opposing leg portions adjacent said body portion is greater than the space between said opposing leg portions adjacent said lip portions.

13. The pipe support as set forth in claim 12 wherein said body portion extends longitudinally between opposing ends defined by downwardly curved lips and an outwardly flared rim extending from and around the perimeter of said body portion.

14. The pipe support as set forth in claim 13 further including a plurality of axial spaced apart structural ribs formed on said outer surface of said body portion along said bottom floor and said sidewalls.

15. In combination, a pipe support adapted to be operatively coupled to an elongated channel for receiving and supporting a pipe, wherein
said channel includes a base and a pair of spaced apart sidewalls extending from said base to an end plate, wherein a flange projects upwardly from each end plate towards said base and defines a slot therebetween; and
said pipe support includes a body portion extending axially between opposite ends and having an inner surface and an outer surface, said body portion including a generally arcuate bottom floor and a pair of spaced apart sidewalls projecting generally upwardly from said bottom floor; and a plurality of axially spaced apart channel clips projecting downwardly from said outer surface of said body portion opposite said sidewalls, said channel clips comprising a leg portion and at least one outwardly flared lip portion adapted for frictionally engaging said sidewalls of said channel for coupling said pipe support to said channel.

16. The combination as set forth in claim 15 further including at least one compression support rib extending from the body portion and generally perpendicular to the planar surface of each leg portion to provide consistent spacing between the leg portions and constant friction against said sidewall of said channel.

17. The combination as set forth in claim 16 wherein said leg portions of said spaced apart channel clips are angled inwardly towards each other from said body portion to said lip portion wherein the space between said opposing leg portions adjacent said body portion is greater than the space between said opposing leg portions adjacent said lip portions.

18. The combination as set forth in claim 17 wherein said body portion of said pipe support extends longitudinally between opposing ends defined by downwardly curved lips and an outwardly flared rim extending from and around the perimeter of said body portion.

19. The combination as set forth in claim 18 wherein said pipe support further includes a plurality of axial spaced apart structural ribs formed on said outer surface of said body portion along said bottom floor and said sidewalls.
